(19) United States
(12) Patent Application Publication
(10) Pub. No.: US 2011/0003595 A1
(43) Pub. Date: Jan. 6, 2011

(54) INTERWORKING AND HANDOVER BETWEEN WIMAX NETWORKS AND OTHER NETWORKS

(76) Inventor: Changhong Shan, Shanghai (CN)

Correspondence Address: Caven & Aghevli LLC;c/o CPA Global, P.O. BOX 52050, MINNEAPOLIS, MN, 55402, US

(21) Appl. No.: 12/920,494

(22) PCT Filed: Mar. 31, 2008
(86) PCT No.: PCT/CN08/00631

§ 371 Date: Sep. 1, 2010

(51) Int. Cl. H04W 36/00

(52) U.S. Cl. 455/436

(57) ABSTRACT

Techniques to manage handovers between WiMAX and other networks are described.

### RELATED APPLICATIONS

None.

### BACKGROUND

Techniques to interwork and perform handovers between WiMAX network and other networks may find utility.

### BRIEF DESCRIPTION OF THE DRAWINGS

The detailed description is described with reference to the accompanying figures, in which:

FIG. 1A is a schematic illustration of a data path in a WiMAX network, according to embodiments.

FIG. 1B is a schematic illustration of a handover procedure between a WiMAX network and a GPRS/UMTS network, according to embodiments.

FIG. 1C is a schematic illustration of a data path in a GPRS/UMTS network, according to embodiments.

FIG. 2 is a schematic illustration of a handover procedure between a WiMAX network and a GPRS/UMTS network, according to embodiments.

FIGS. 3-7 are a schematic illustrations of a interworking procedures between a WiMAX network and a GPRS/UMTS network, according to embodiments.

### DETAILED DESCRIPTION

Described herein are exemplary systems and methods for performing handover and interworking operations between WiMAX network and other networks. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

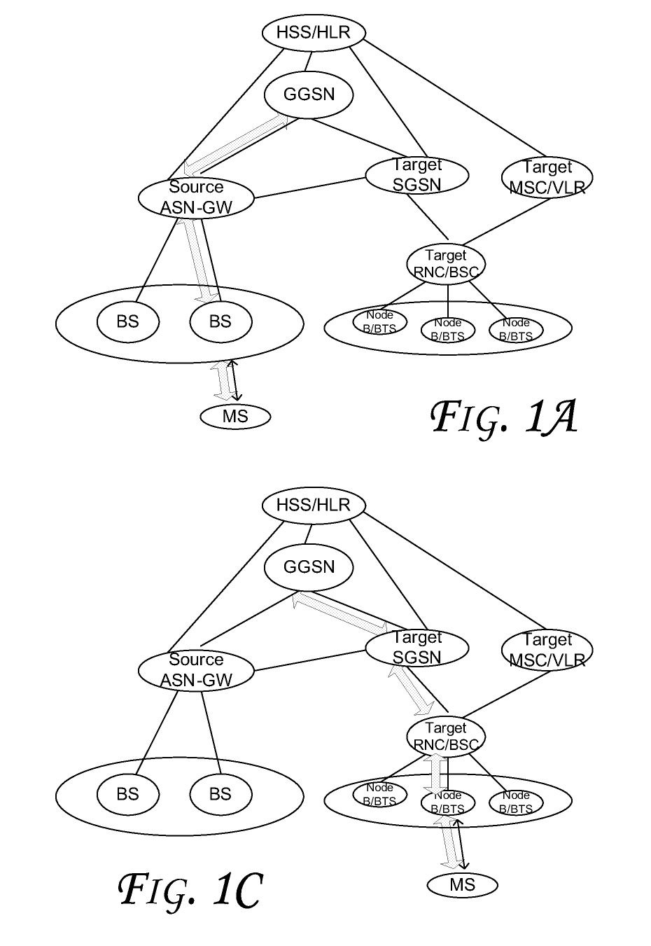

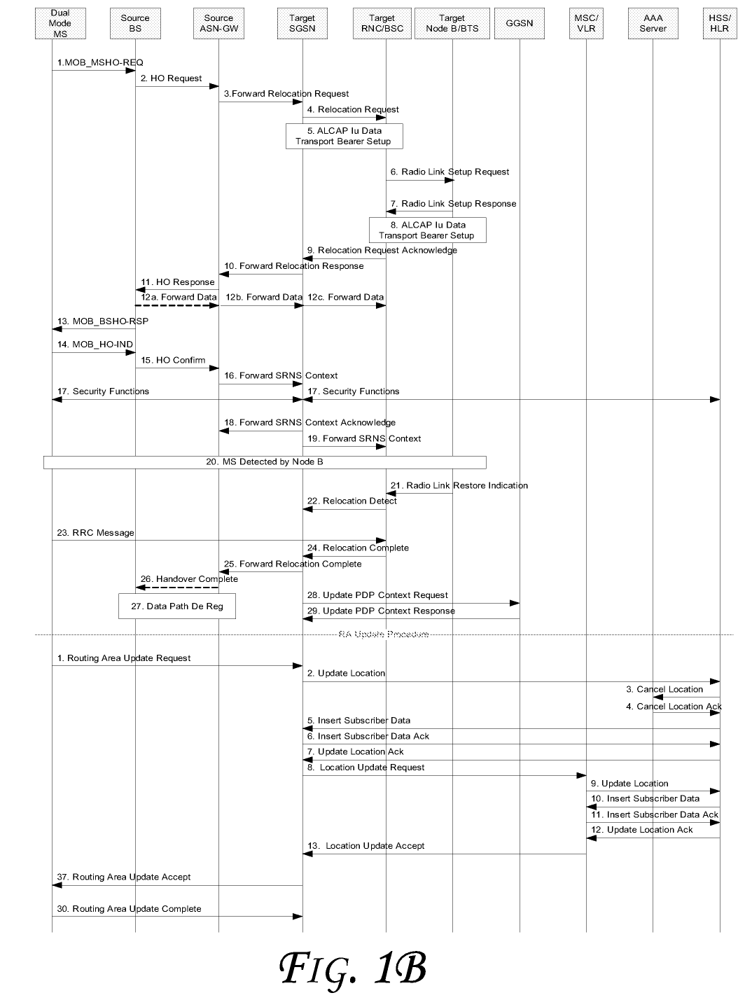

In some embodiments, there is provided a method to manage handoff operations between a WiMAX network and a GPRS/UMTS network. FIG. 1A is a schematic illustration of a data path in a WiMAX network, according to embodiments. Referring to FIG. 1A, a data path exists between a mobile station (MS), a base station (BS) a source access service network gateway (ASN-GW), and a gateway GPRS support node (GGSN). The GGSN may be coupled to a HSS home location register (HSS/HLR).

FIG. 1B is a schematic illustration of a handover procedure between a WiMAX network and a GPRS/UMTS network, according to embodiments. Referring to FIG. 1B, the MS sends a MOB_MSHO-REQ to the source BS to indicate that it wants to initiate a handover. The target radio network controller (RNC) and/or Node B identifier may be included in this message.

If source BS agrees to trigger a handover for MS then the Source BS sends HO Request to source ASN-GW to indicate a handover for this MS. After receiving the HO Request, the source ASN-GW sends a Forward Relocation Request to a Target Serving GPRS Support Node (SGSN). The request includes the necessary information that Target SGSN needs to establish a transport bearer for this MS. For data integrity purpose, PDU information may be included in it.

The target SGSN sends Relocation Request to target RNC including some or all the context which is retrieved from the source ASN-GW. According to the context received by target SGSN and target RNC, Access Link Control Application Protocol (ALCAP) 1u Data Transport Bearer is established. The target RNC then sends a Radio Link Setup Request to target Node B requesting to prepare radio link resource allocation. Then target Node B replies with Radio Link Setup Response to the target RNC.

According to the context received by target RNC and Target Node B, ALCAP Iub Data Transport Bearer is set up between target RNC and Node B. The target RNC sends Relocation Request Acknowledge to the target SGSN. The target SGSN sends Forward Relocation Response to source ASN-GW. The source ASN-GW sends HO Response to source BS.

If data is buffered in source BS, then the source BS will forward data to source ASN-GW, then the ASN-GW forwards it to target SGSN, then to target RNC. If data is buffered in source ASN-GW, the ASN-GW can directly forward data to target SGSN, then to target RNC. The source BS the sends MOB_BSHO-RSP to the MS, and the MS sends MOB_HO-IND to source BS including the target RNC and Node B identifier which the MS wants to hand over to.

The source BS then sends HO Confirm to source ASN-GW indicating the identifier of the target RNC and Node B. The source ASN-GW sends Forward SRNS Context to target SGSN. The purpose of this procedure is to transfer Source ASN contexts to target RNC and to move Serving ASN role to target RNC. The context may include the next PDU sequence number for uplink and downlink directions. Serving ASN-GW shall map the GRE PDU sequence number to GTP PDU sequence number.

On receiving the context from the source ASN-GW, a security function shall work to verify if the MS is valid or not, and if the security functions do not authenticate the MS correctly, the handover procedure will fail. After security function is successfully executed, the target SGSN replies a Forward SRNS Context Acknowledge to the source ASN-GW to confirm that the SRNS context has been received and the MS has been verified as valid.

The target SGSN send Forward SRNS Context to the target RNC. The target SGSN may map the GTP PDU sequence number to PDCP PDU sequence number on uplink and downlink directions respectively. The MS is detected by target Node B. Target Node B sends Radio Link Restore Indication to the target RNC. The target RNC sends Relocation Detect to target SGSN indicating that the MS has been detected by target RNC.

When the MS has reconfigured itself, it sends an RRC message e.g., a Physical Channel Reconfiguration Complete message to the target SRNC. When the target SRNC receives the appropriate RRC message, e.g. Physical Channel Reconfiguration Complete message or the Radio Bearer Release Complete message in UTRAN case, or the Handover to UTRAN Complete message or Handover Complete message in GERAN case, i.e. the new SRNC-ID+S-RNTI are successfully exchanged with the MS by the radio protocols, the target SRNC shall initiate a Relocation Complete procedure by sending the Relocation Complete message to the new SGSN. The purpose of the Relocation Complete procedure is to indicate by the target SRNC the completion of the relocation of the SRNS to the CN. The target SGSN sends Forward Relocation Complete to the source ASN-GW to tell it that the relocation is completed in target network.

The source ASN-GW sends Handover Complete to source BS, then the data path between source BS and ASN-GW is deregistered. The data path deregistration procedure can be initiated by source BS or ASN-GW. The target SGSN updates the PDP Context with GGSN. The GGSN updates their PDP context fields and return an Update PDP Context Response message. FIG. 1C is a schematic illustration of a data path in a GPRS/UMTS network, according to embodiments.

In some embodiments the system implements a routing area (RA) Update Procedure. When MS has handed over to the new 3GPP network, it sends a Routing Area Update Request to the target SGSN to request routing area update. In order to update the routing area information, target SGSN sends Update Location to the HSS/HLR including the current routing area information for this MS. The HSS/HLR recognizes that the latest area information points to the AAA Server, so the HSS/HLR will send Cancel Location to AAA Server. After receiving the Cancel Location, the AAA Server can delete the stored MS session information, then replies with Cancel Location Ack.

The HSS/HLR sends Insert Subscriber Data to the new SGSN to tell it the subscriber related data, and SGSN replies with Insert Subscriber Data Ack. The HSS/HLR responses Update Location with Update Location Ack. If MS is in mode I or class A, the SGSN will send Location Update Request to the MSC/VLR. When receiving the Location Update Request, MSC/VLR can send Update Location to HSS/HLR.

The HSS/HLR will then send the subscriber data to MSC/VLR by using Insert Subscriber Data, and MSC/VLR responses with Insert Subscriber Data Ack. After inserting the subscriber data into MSC/VLR, the HSS/HLR sends Update Location Ack to the MSC/VLR. After receiving Update Location Ack, MSC/VLR sends Location Update Accept to SGSN, then SGSN sends Routing Area Update Accept to the MS. After receiving Routing Area Update Accept, the MS responses with Routing Area Update Complete to SGSN.

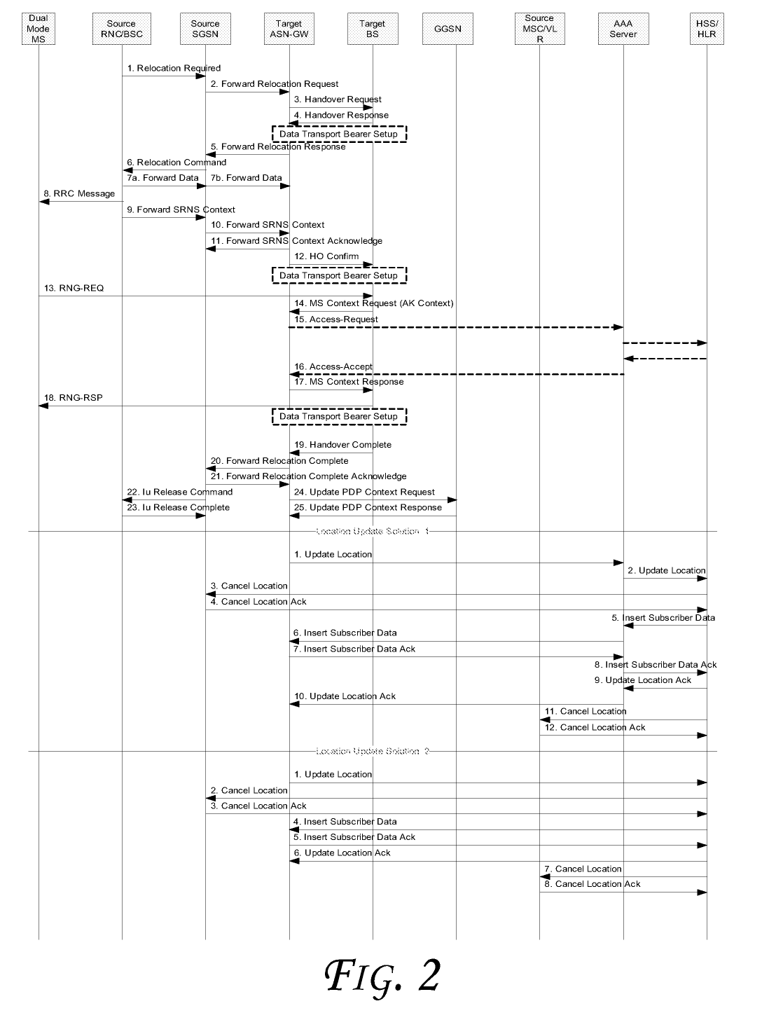

FIG. 2 is a schematic illustration of a handover procedure between a WiMAX network and a GPRS/UMTS network, according to embodiments. Referring to FIG. 2, based on measurement results and knowledge of RAN topology, the source SRNC decides to initiate a combined hard handover and SRNS relocation. The Source RNC sends Relocation Required to Source SGSN to request relocation. The source SGSN determines from the Target ID if the SRNS relocation is intra-SGSN relocation is intra-SGSN SRNS relocation or inter-SGSN SRNS relocation. In case of inter-SGSN SRNS relocation the source SGSN initiates the relocation resource allocation procedure by sending Forward Relocation Request message to target ASN-GW.

The target ASN-GW sends Handover Request to the target BS to ask BS if it can admit the MS to access. Target BS replies with Handover Response to target ASN-GW. The target ASN-GW sends Forward Relocation Response to the source SGSN including the context from target BS. The source SGSN sends Relocation Command to source RNC indicating that the target BS can accept the MS.

For data integrity purpose, the source RNC will forward data to source SGSN, then SGSN forwards data to target ASN-GW. The source RNC sends RRC message (e.g., Physical Channel Reconfiguration in UTRAN case, or Handover From UTRAN, or Handover Command in GERAN Iu mode case) to the MS indicating handover. The source RNC sends Forward SRNS Context to source SGSN. SRNS contexts are sent for each concerned RAB and contain the sequence numbers of the GTP PDUs next to be transmitted in the uplink and downlink directions and the next PDCP sequence numbers that would have been used to send and receive data from the MS. The source SGSN forward SRNS Context to the target ASN-GW including the context received from source RNC.

When receiving the SRNS Context from source SGSN, target ASN-GW replies with Forward SRNS Context Acknowledge. The target ASN-GW sends HO Confirm to target BS indicating the MS will hand over here. Data path between ASN-GW and BS may be set up after HO Confirm. The MS sends RNG-REQ to the target BS to request to enter network. The target BS ask target ASN-GW for AK context. If the target ASN-GW can't supply or derive AK context for the MS, it will contact with AAA Server to get Root key and its lifetime, if AAA Server can't supply the Root key, it can contact with HSS/HLR to get key material. AAA Server sends Access-Accept to target ASN-GW, then the target ASN-GW derive the related security context and sends AK context to the target BS.

After getting the security context and verifying the MS as valid, target BS will send RNG-RSP to MS. Data path between BS and ASN-GW may be established here. The BS sends Handover Complete to the ASN-GW. The ASN-GW sends Forward Relocation Complete to source SGSN, and source SGSN responses with Forward Relocation Complete Acknowledge. The SGSN sends Iu Release Command to source RNC and release the Iu interface, then source RNC replies with Iu Release Complete.

After receiving Forward Relocation Complete Acknowledge, the ASN-GW sends Update PDP Context Request to the GGSN, and GGSN will update PDP Context for the MS, then responses with Update PDP Context Response. There may be two different kinds of location update procedures, one is via AAA Server, the other is to send Update Location directly to HSS/HLR. As to the first method, it is no need for ASN-GW to implement MAP.

In some embodiments, the system may implement a location update. For example, the Target ASN-GW sends Update Location to HSS/HLR via AAA Server. When recognizing the MS has attached to a new Access Network (this can be done by reading the identifier of ASN-GW), the HSS/HLR send Cancel Location to source SGSN, then SGSN can delete related session context for this MS and replies with Cancel Location Ack. After receiving Cancel Location Ack, HSS/HLR will insert subscriber data to new ASN-GW via AAA Server, this can be achieved by using Insert Subscriber Data and Insert Subscriber Data Ack.

After inserting subscriber data to new ASN-GW, HSS/HLR will response with Update Location Ack via AAA Server. If MS was in Mode I or Class A in 3GPP network, HSS/HLR will also send Cancel Location to MSC/VLR, and MSC/VLR can delete MS related session context, then replies with Cancel Location Ack.

In another example of a location update routine, a target ASN-GW sends Update Location to HSS/HLR. When recognizing the MS has attached to a new Access Network(this can be done by reading the identifier of ASN-GW), HSS/HLR send Cancel Location to source SGSN, then SGSN can delete related session context for this MS and replies with Cancel Location Ack. After receiving Cancel Location Ack, HSS/HLR will insert subscriber data to new ASN-GW, this can be achieved by using Insert Subscriber Data and Insert Subscriber Data Ack. After inserting subscriber data to new ASN-GW, HSS/HLR will response with Update Location Ack.

If MS was in Mode I or Class A in 3GPP network, HSS/HLR will also send Cancel Location to MSC/VLR, and MSC/VLR can delete MS related session context, then replies with Cancel Location Ack.

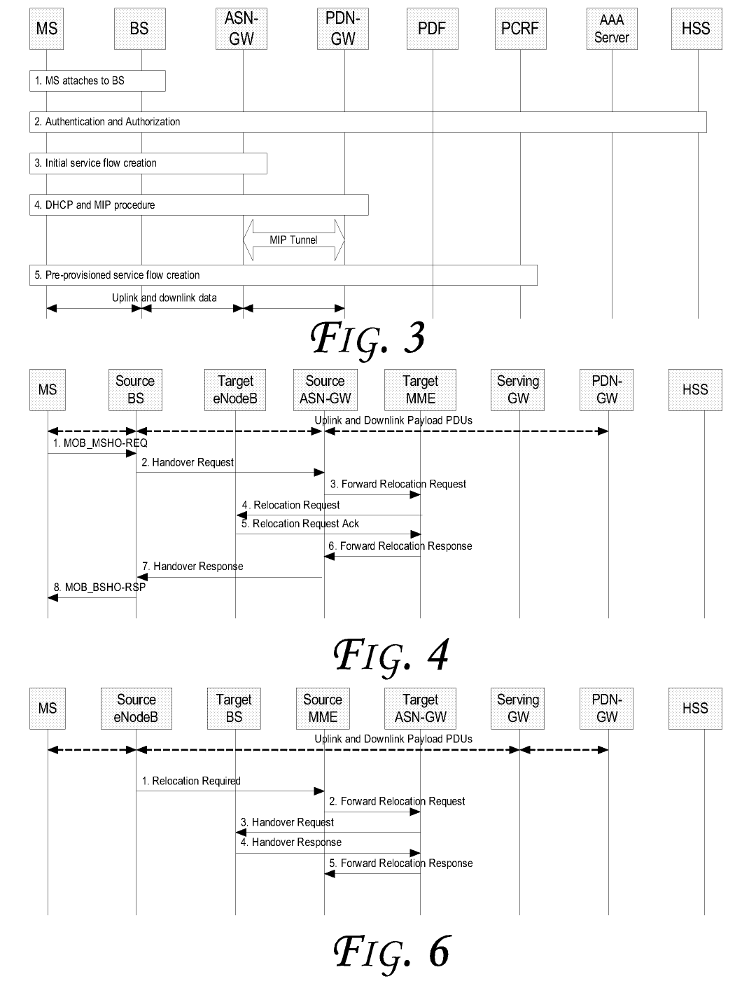

In another implementation, the system provides techniques to perform interworking between a WiMAX network and other networks. FIGS. 3-7 are a schematic illustrations of a interworking procedures between a WiMAX network and a GPRS/UMTS network, according to embodiments.

Referring to FIG. 3, initially, the MS attaches with BS in the air interface to do time, power, frequency synchronization, etc. Authentication occurs between MS and HSS via AAA Client on the ASN-GW and AAA Server. If it is roaming case, there will be a AAA Proxy in the visited CSN and AAA Server will be in home CSN. If authentication is successfully completed, the AAA Server will inform visited CSN, then visited CSN informs ASN that the MS is authorized. At the same time, subscriber information will be sent to ASN. In order to carry DHCP and MIP messages, initial service flow is arranged between BS and ASN-GW, and a DHCP and MIP procedure occurs.

If there is DHCP Proxy in the ASN-GW, the DHCP procedure will occur between MS and ASN-GW. If there is DHCP Agent in the ASN-GW, the DHCP procedure will occur among MS, ASN-GW and DHCP Server. If it's Client MIPv4 case, MIP procedure will occur among MS, ASN-GW and PDN-GW. If it's Proxy MIPv4 case, MIP procedure will occur between ASN-GW and PDN-GW. If it's Proxy MIPv6 case, MIP Procedure will occur between ASN-GW and PDN-GW. After successful MIP registration, MIP Tunnel exists between ASN-GW and PDN-GW. After MIP registration, pre-provisioned service flow procedure occurs among MS, BS, ASN-GW, PDF and PCRF. If it's roaming case, there will be a V-PCRF in visited CSN.

FIG. 4 is a schematic illustration of operations in a preparation phase for performing a handoff between a WiMAX network and a SAE network. Before handover occurs, uplink and downlink payload PDUs will be transferred among MS, Source BS, Source ASN-GW and PDN-GW.

In the embodiment depicted in FIG. 4, the MS sends MOB_MSHO-REQ to source BS indicating handover. A list of candidate target eNodeB will be included. The source BS sends Handover Request to source ASN-GW including the list of target eNodeB identifier which it wants to handover to. MS's Power, frequency, time and capability information may be included in this message. The source ASN-GW inquires the location of the each target eNodeB and finds the target MME, then it sends Forward Relocation Request to each target MME indicating handover preparation. MS's Power, frequency, time and capability information may be included in this message.

The target MME then sends Relocation Request to target eNodeB indicating handover preparation. MS's Power, frequency, time and capability information may be included in this message. The target eNodeB compares it's own capability with the information of the MS, and determines if the MS can handover to it. If it can accept the MS, it sends Relocation Request Ack to target MME including its frequency, time and capability information. The target MME sends Forward Relocation Response to the source ASN-GW. Target eNodeB's frequency, time and capability information may be included. The source ASN-GW collects the response from each target eNodeB and sends Handover Response to the source BS. Target eNodeB's frequency, time and capability information may be included. Finally, the source BS determines sends the list of candidate eNodeB to the MS including their capability information.

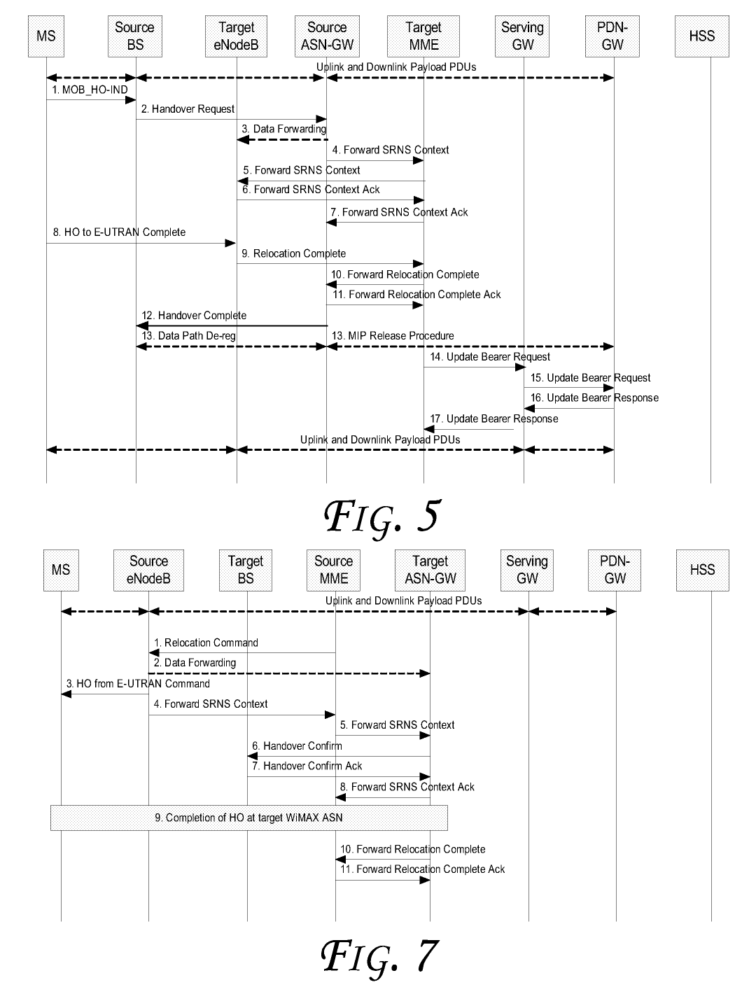

FIG. 5 is a schematic illustration of the handover phase, according to embodiments. Referring to FIG. 5, initially, the MS determines the target eNodeB which it wants to handover to, then sends MOB_HO-IND to source BS including the identifier of target eNodeB. The Source BS then sends Handover Request to source ASN-GW including the identifier of the target eNodeB and MS Context on it. Data forwarding may happen between source ASN and target eNodeB.

The Source ASN-GW sends Forward SRNS Context to target MME including MS Context. The target MME sends Forward SRNS Context to target eNodeB including MS Context. The target eNodeB replies target MME with Forward SRNS Context Ack. The target MME replies source ASN-GW with Forward SRNS Context Ack. The MS attaches to target eNodeB.

After it receives HO to E-UTRAN Complete, target eNodeB sends Relocation Complete to target MME. The target MME sends Forward Relocation Complete to source ASN-GW, and source ASN-GW replies with Forward Relocation Complete Ack message. The source ASN-GW sends Handover Complete to source BS. Data path between BS and ASN-GW is deregistered, MIP release procedure occurs.

The target MME sends Update Bearer Request to serving GW including the target eNodeB identifier, then serving GW forwards Update Bearer Request to PDN-GW. PDN-GW replies with Update Bearer Response to serving GW, then serving GW sends Update Bearer Response to target MME. Data bearer is set up among target eNodeB, serving GW and PDN-GW. Uplink and downlink payload PDUs is transferred among MS, eNodeB, serving GS and PDN-GW.

FIG. 6 is a schematic illustration of operations in a preparation phase for performing a handoff between a SAE network and a WiMAX network. Referring to FIG. 6, when detecting the MS needs to do relocation, source eNodeB sends Relocation Required to source MME indicating handover. The identifier of the target BS is included in this message. MS and eNodeB capability, power, frequency and time information may be included. The source MME inquires the location of the BS, then sends Forward Relocation Request to target ASN-GW under which the target BS locates. MS and eNodeB capability, power, frequency and time information may be included. The target ASN-GW sends Handover Request to target BS. MS and eNodeB capability, power, frequency and time information may be included. The target BS deals with the request and replies with Handover Response to target ASN-GW. The target ASN-GW replies with Forward Relocation Response to target BS.

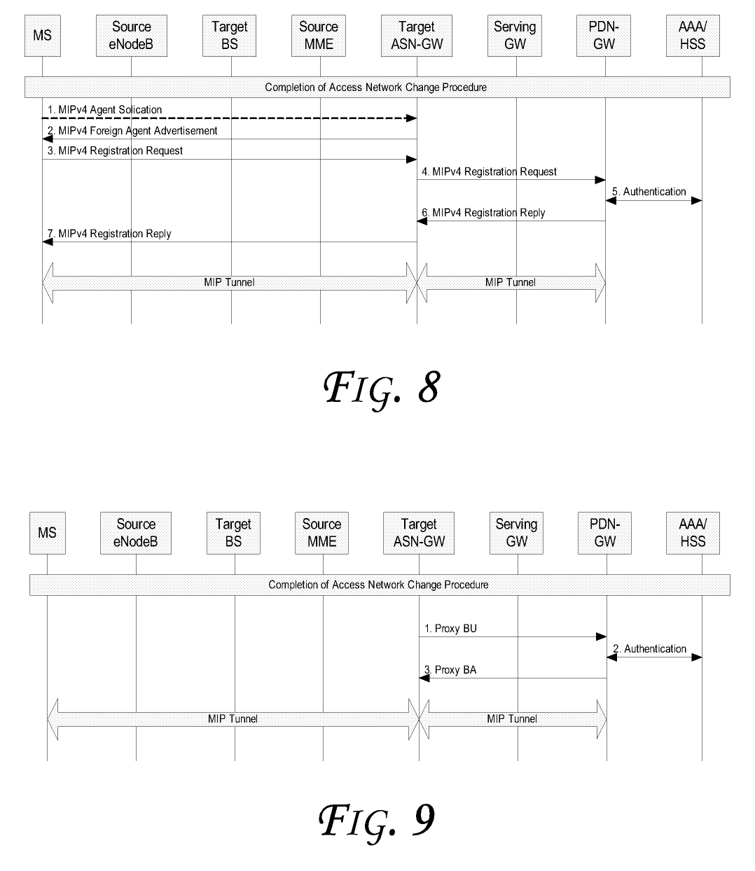

FIG. 7 is a schematic illustration of operations in an execution phase for performing a handoff between a SAE network and a WiMAX network. Referring to FIG. 7, Initally, the source MME sends a Relocation Command to source eNodeB indicating handover execution phase begins. When source eNodeB receives Relocation Command, it may start data forwarding to target ASN-GW.

Source eNodeB sends HO from E-UTRAN Command to MS indicating handover, target BS identifier is included in this message. The Source eNodeB forward SRNS Context to source MME by using Forward SRNS Context including MS session information. Target BS identifier is included in this message.

The Source MME sends Forward SRNS Context to target ASN-GW. MS session information may be included in this message. Target BS identifier is included in this message. The target ASN-GW sends Handover Confirm to the target BS. MS session information may be included in this message.

The target BS replies with Handover Confirm Ack to target ASN-GW. Target ASN-GW replies source MME with Forward SRNS Context Ack message. Handover is completed in target WiMAX network, and ASN-GW sends Forward Relocation Complete to source MME indicating handover is completed in target network.

After handover procedure and Initial Service Flow is set up, MIP phase starts. Referring to FIG. 8, if the MS can't receive the MIPv4 Foreign Agent Advertisement message, MS may send MIPv4 Agent Solication to target ASN-GW. Next, the FA in ASN-GW advertises MIPv4 Foreign Agent Advertisement to MS. The MS then sends MIPv4 Registration Request to the FA in ASN-GW to intiate MIPv4 registration, and the FA forwards MIPv4 Registration Request to PDN-GW.

The PDN-GW requires authentication from AAA server or HLR. If authentication is successful, AAA server or HLR may update the PDN-GW address record for the MS. The PDN-GW sends MIPv4 Registration Reply to FA in the ASN-GW, and the FA in the ASN-GW replies with MIPv4 Registration Reply to MS.

In some embodiments, a MIP Tunnel is established among MS, ASN-GW and PDN-GW. After handover procedure and Initial Service Flow is set up, MIP phase starts. Referring to FIG. 9, first a PMIPv6 Client in ASN-GW sends Proxy Binding Update to PDN-GW. Then the PDN-GW requires authentication from AAA server or HLR. If authentication is successful, AAA server or HLR may update the PDN-GW address record for the MS. Finally, the PDN-GW replies with Proxy Binding Ack to ASN-GW.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to manage handovers between a WiMAX network and a GPRS/UMTS network, comprising:
initiating, in a mobile station, a request to initiate a handover from the WiMAX network to the GPRS/UMTS network; and
transmitting the request to a base station;
transmitting the request to a target radio network controller (RNC)
establishing an Access Link Control Application Protocol transport bearer;
transmitting an acknowledgement from the target radio network controller (RNC) to the mobile station; and
transmitting a confirmation from the mobile station to the radio network controller (RNC).

2. The method of claim 1, wherein transmitting the request to a target radio network controller comprises transmitting the request via a Serving GPRS Support Node.

3. The method of claim 1, further comprising implementing one or more security operations.

4. The method of claim 1, further comprising updating a data path between the mobile station and radio network controller.

5. The method of claim 1, further comprising updating a location parameter associated with the mobile station.

6. The method of claim 1, further comprising updating subscriber data associated with the mobile station.

7. The method of claim 1, further comprising deregistering a data path associated with the mobile station.

8. A method to manage handovers between a WiMAX network and an SAE network, comprising:
initiating, in a mobile station, a request to initiate a handover from the WiMAX network to the SAE network; and
transmitting the request to a base station;
transmitting the request to a target radio network controller (RNC)
establishing an Access Link Control Application Protocol transport bearer;
transmitting an acknowledgement from the target radio network controller (RNC) to the mobile station; and
transmitting a confirmation from the mobile station to the radio network controller (RNC).

9. The method of claim 8, wherein transmitting the request to a target radio network controller comprises transmitting the request via a Serving GPRS Support Node.

10. The method of claim 8, further comprising implementing one or more security operations.

11. The method of claim 8, further comprising updating a data path between the mobile station and radio network controller.

12. The method of claim 8, further comprising updating a location parameter associated with the mobile station.

13. The method of claim 8, further comprising updating subscriber data associated with the mobile station.

14. The method of claim 8, further comprising deregistering a data path associated with the mobile station.
